(19) United States
(12) Patent Application Publication
(10) Pub. No.: US 2026/0337302 A1
(43) Pub. Date: Oct. 29, 2026

(54) SKIN-INSPIRED HYDRO-SOFTENED FLEXIBLE CHITOSAN FILMS

(71) Applicant: Georgia Tech Research Corporation, Atlanta, GA (US)

(72) Inventors: Hojin Seo, Atlanta, GA (US); Tequila A.L. Harris, Atlanta, GA (US); Xiaoqing Yu, Atlanta, GA (US)

(21) Appl. No.: 19/659,817

(22) Filed: Apr. 27, 2026

Related U.S. Application Data
(60) Provisional application No. 63/794,628, filed on Apr. 25, 2025.

(51) Int. Cl. C08B 37/08; C08J 5/18

(52) U.S. Cl. CPC C08B 37/003; C08J 5/18

(57) ABSTRACT

The present disclosure relates generally to polysaccharide thin films and methods for modifying their mechanical properties, and more particularly to hydro-softened chitosan films exhibiting enhanced flexibility through controlled interfacial water confinement during substrate-mediated processing. A hydro-softened chitosan film includes a chitosan layer including interface-confined water molecules entrapped within amorphous hydrogen-bonded domains of the chitosan layer. The interface-confined water molecules include freezing bound water held by hydrogen bonds between amine and hydroxyl groups of the chitosan layer. The chitosan layer exhibits an elastic modulus that is reduced relative to an unsoftened chitosan film lacking the interface-confined water molecules. The chitosan layer is free of apparent surface moisture.

### CROSS-REFERENCE TO RELATED APPLICATIONS

This application claims the benefit of U.S. Provisional Application Ser. No. 63/794,628, filed on 25 Apr. 2025, which is incorporated herein by reference in its entirety as if fully set forth below.

### FIELD OF INVENTION

The present disclosure relates to polysaccharide thin films and methods for modifying their mechanical properties, and more particularly to hydro-softened chitosan films exhibiting enhanced flexibility through controlled interfacial water confinement during substrate-mediated processing.

### BACKGROUND

Polysaccharide thin films have attracted considerable interest across a range of technological applications, including coatings, packaging, membranes, and biomedical interfaces. Among polysaccharides, chitosan—a naturally derived biopolymer known for its antimicrobial and biocompatible properties—has emerged as a material of particular interest. Chitosan films may be fabricated through various processing techniques, including spin-coating and solution casting, and may be deposited onto substrates such as poly(dimethylsiloxane) (PDMS) to form bilayer structures. The mechanical properties of polysaccharide films are sensitive to their hydration state, and water is known to modulate polysaccharide chain mechanics through plasticization and swelling by disrupting intermolecular networks.

However, existing approaches for modifying the mechanical properties of polysaccharide films suffer from several limitations. Chitosan, for example, exhibits inherent stiffness that reflects the highly crystalline organization of its β-1,4-linked glucosamine structure and the dense network of interchain hydrogen bonding. This rigidity restricts the use of chitosan in soft and flexible systems. Conventional methods for achieving flexibility in chitosan-based films have typically required plasticizers, chemical crosslinkers, copolymerization, or mechanical integration with softer substrates. These approaches often compromise the chemical identity and compositional purity of the chitosan material. Furthermore, while water-mediated plasticization and swelling mechanisms are well understood for bulk or loosely bound water, these classical descriptions fail to account for the complex interfacial behaviors observed in thin films or confined geometries. A generalizable framework describing how water may be confined within interfacial polymer networks and how this confinement influences bulk mechanical properties has remained absent.

What is needed, therefore, is an improved approach for modifying the mechanical properties of polysaccharide films that achieves enhanced flexibility while preserving the chemical identity and compositional purity of the polysaccharide material. Such an approach would enable the fabrication of soft and flexible polysaccharide films suitable for applications requiring simultaneous mechanical compliance and functional integrity.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A hydro-softened chitosan film can include a chitosan layer including interface-confined water molecules entrapped within amorphous hydrogen-bonded domains of the chitosan layer. The interface-confined water molecules can include freezing bound water held by hydrogen bonds between amine and hydroxyl groups of the chitosan layer. The chitosan layer can exhibit an elastic modulus that is reduced relative to an unsoftened chitosan film lacking the interface-confined water molecules. The chitosan layer can be free of apparent surface moisture.

A method of fabricating a hydro-softened chitosan film can include preparing a chitosan solution by dissolving and protonating chitosan in a dilute acidic solution. The method can include adding a silane precursor to the chitosan solution to form a silanized chitosan sol. The method can include preparing a polymer substrate. The method can include curing the polymer substrate at a curing temperature. The method can include treating a surface of the cured polymer substrate to introduce hydroxyl groups on the surface. The method can include depositing the silanized chitosan sol onto the treated surface of the cured polymer substrate. The method can include allowing condensation of the silanized chitosan sol on the treated surface to form a chitosan layer having interface-confined water molecules entrapped within amorphous hydrogen-bonded domains of the chitosan layer.

A flexible polysaccharide film can include a polysaccharide layer including amorphous hydrogen-bonded domains. The amorphous hydrogen-bonded domains can include interface-confined water molecules held by hydrogen bonds within the polysaccharide layer. The interface-confined water molecules can include freezing bound water that exhibits a cold crystallization exotherm at a sub-zero temperature. The polysaccharide layer can exhibit a reduced elastic modulus relative to an unsoftened polysaccharide film of the same composition lacking the interface-confined water molecules. The polysaccharide layer can be free of apparent surface moisture.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a bilayer film having a chitosan layer disposed on a PDMS substrate, according to examples of the disclosed technology.

FIG. 2 is a flow diagram for a method for fabricating a hydro-softened chitosan film, according to examples of the disclosed technology.

FIG. 3 illustrates FTIR spectra comparing UV treated and untreated samples, according to examples of the disclosed technology.

FIG. 4A illustrates a cross-sectional scanning electron microscope image of a bilayer film, according to examples of the disclosed technology.

FIG. 4B illustrates a magnified cross-sectional view of an interface region of the bilayer film of FIG. 4A, according to examples of the disclosed technology.

FIG. 5A illustrates substrate elastic modulus as a function of substrate processing temperature, according to examples of the disclosed technology.

FIG. 5B illustrates chitosan elastic modulus as a function of substrate processing temperature, according to examples of the disclosed technology.

FIG. 5C illustrates power spectral density comparing unsoftened and hydro-softened chitosan, according to examples of the disclosed technology.

FIG. 5D illustrates elasticity and hardness measurements for unsoftened and hydro-softened chitosan films, according to examples of the disclosed technology.

FIG. 6A illustrates differential scanning calorimetry curves comparing hydro-softened and unsoftened chitosan films, according to examples of the disclosed technology.

FIG. 6B illustrates Fourier transform infrared spectroscopy data comparing hydro-softened and unsoftened chitosan films, according to examples of the disclosed technology.

FIG. 6C illustrates thermogravimetric analysis data comparing hydro-softened and unsoftened chitosan films, according to examples of the disclosed technology.

FIG. 6D illustrates contact angle measurements as a function of substrate treatment temperature, according to examples of the disclosed technology.

FIG. 7 illustrates normalized hydration as a function of radius comparing unsoftened and hydro-softened chitosan, according to examples of the disclosed technology.

FIG. 8 illustrates softness as a function of chitosan purity for various processing methods, according to examples of the disclosed technology.

FIG. 9A illustrates total bacteria count data for a first sample condition, according to examples of the disclosed technology.

FIG. 9B illustrates total bacteria count data for a second sample condition, according to examples of the disclosed technology.

FIG. 9C illustrates single bacteria count data for a first sample condition, according to examples of the disclosed technology.

FIG. 9D illustrates single bacteria count data for a second sample condition, according to examples of the disclosed technology.

FIG. 9E illustrates aggregated bacteria count data for a first sample condition, according to examples of the disclosed technology.

FIG. 9F illustrates aggregated bacteria count data for a second sample condition, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to hydro-softened polysaccharide films and methods for modifying the mechanical properties of polysaccharide materials through controlled interfacial water confinement during substrate-mediated processing. In some aspects, the disclosed technology provides flexible polysaccharide films, such as chitosan films, that exhibit reduced elastic modulus while preserving the chemical identity and compositional purity of the polysaccharide material.

Polysaccharide thin films can be used in a range of technological applications, including coatings, packaging, membranes, and biomedical interfaces. Chitosan, a naturally derived biopolymer, can exhibit antimicrobial and biocompatible properties. Chitosan films can be fabricated through various processing techniques, including spin-coating and solution casting, and can be deposited onto substrates such as poly(dimethylsiloxane) (PDMS) to form bilayer structures. The mechanical properties of polysaccharide films can be sensitive to their hydration state, and water can modulate polysaccharide chain mechanics through plasticization and swelling by disrupting intermolecular networks.

Chitosan can exhibit inherent stiffness that reflects the highly crystalline organization of its β-1,4-linked glucosamine structure and the dense network of interchain hydrogen bonding. This rigidity can restrict the use of chitosan in soft and flexible systems. Conventional methods for achieving flexibility in chitosan-based films can include plasticizers, chemical crosslinkers, copolymerization, or mechanical integration with softer substrates. These approaches can compromise the chemical identity and compositional purity of the chitosan material.

The disclosed technology introduces a water-driven mechanism, referred to herein as hydro-softening, that can render polysaccharide films soft and stretchable during thin-film processing. In some aspects, substrate effects during processing can reorganize hydration clusters on the polymer chain, generating disjoining pressure and raising configurational entropy, with mechanical softening arising as a thermodynamic response. The disclosed technology can provide polysaccharide films in which interface-confined water molecules are entrapped within amorphous hydrogen-bonded domains of the polysaccharide layer. The interface-confined water molecules can include freezing bound water held by hydrogen bonds between amine and hydroxyl groups of the polysaccharide layer.

In some aspects, the disclosed technology is inspired by the natural hydration mechanism of human skin, where glycosaminoglycans in the dermis entrap water to enhance softness and flexibility. In human skin, hydrogen bonding and steric crowding can reorganize confined water within hydroxyl-rich glycosaminoglycan domains, generating local disjoining pressure without measurable volumetric expansion. The disclosed hydro-softening process can reduce rigidity and improve flexibility through process-driven control over interfacial condensation and water retention.

The disclosed technology can provide hydro-softened chitosan films that exhibit a reduced elastic modulus relative to unsoftened chitosan films lacking interface-confined water molecules. In some aspects, the elastic modulus of chitosan films can decrease from values in a range of about 80 MPa to about 95 MPa for unsoftened films to values in a range of about 30 MPa to about 35 MPa or less for hydro-softened films. In some cases, the elastic modulus can be reduced to values of about 11 MPa or less. The disclosed values are exemplary only, and other values are contemplated within the scope of the present disclosure.

The disclosed technology can provide methods of fabricating hydro-softened chitosan films that include preparing a chitosan solution by dissolving and protonating chitosan in a dilute acidic solution, adding a silane precursor such as tetraethyl orthosilicate (TEOS) to form a silanized chitosan sol, preparing and curing a polymer substrate at a curing temperature, treating a surface of the cured polymer substrate to introduce hydroxyl groups, depositing the silanized chitosan sol onto the treated surface, and allowing condensation to form a chitosan layer having interface-confined water molecules entrapped within amorphous hydrogen-bonded domains.

In some aspects, the curing temperature of the polymer substrate can be selected to control a stiffness of the polymer substrate, and increasing the stiffness of the polymer substrate can increase a volume of the interface-confined water molecules in the chitosan layer. The accumulation of steric hindrance arising from the hardening of the substrate at different temperatures can alter water retention within the amine-hydroxyl-rich amorphous domains of chitosan. As steric resistance increases, the process can become less efficient at expelling residual water, thereby increasing the volume of confined water and reducing the elastic modulus of the resulting chitosan film.

The presence of interface-confined water in hydro-softened chitosan films can be confirmed through various characterization techniques. Differential scanning calorimetry (DSC) can reveal a distinct cold crystallization exotherm at sub-zero temperatures in hydro-softened chitosan, which can be absent in unsoftened chitosan. Fourier transform infrared (FTIR) spectroscopy can show a distinct O-H absorption peak at approximately 3400 cm⁻¹ superimposed on a broad amine-hydroxyl band between 3200 and 3500 cm⁻¹ in hydro-softened chitosan films. Thermogravimetric analysis (TGA) can show greater mass decomposition above 100 degrees Celsius in hydro-softened chitosan films compared to unsoftened films, indicating the presence of tightly bound water that persists beyond the boiling point of unbound water.

The disclosed hydro-softened polysaccharide films can be free of apparent surface moisture while exhibiting reduced elastic modulus. The resulting films are neither plasticized nor swollen, but instead represent a thermodynamically-driven, water-mediated response that preserves a level of compositional purity that can be compromised in conventional methods of softening. In some aspects, the chitosan layer can have a chitosan purity of at least 75 weight percent, or at least 80 weight percent.

The disclosed technology can provide applications in bio-adhesive coatings, wound dressings, wearable sensors, flexible and wearable healthcare electronics, advanced barrier coating technology, and other biomedical applications. The direct link between process parameters and mechanical properties can enable flexibility to be tailored for specific applications.

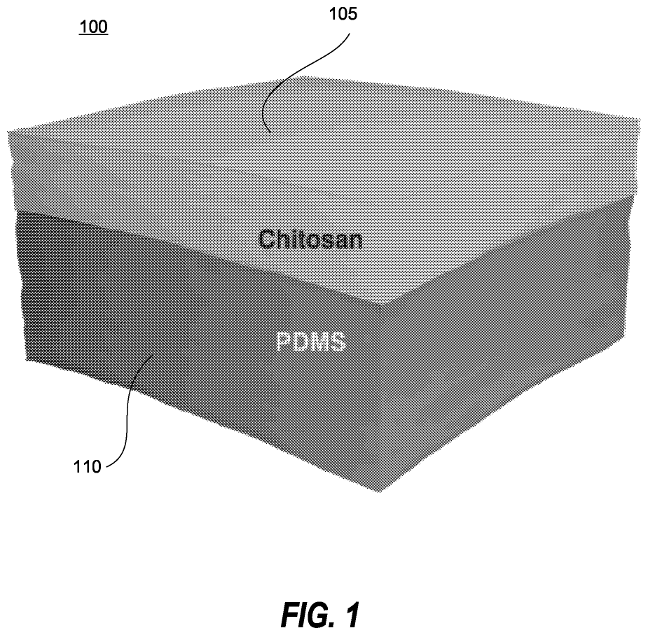

FIG. 1 illustrates a bilayer film 100 according to examples of the disclosed technology. The bilayer film 100 can include a chitosan layer 105 disposed on a PDMS substrate 110. The chitosan layer 105 can be positioned on top of the PDMS substrate 110, forming a layered structure in which the PDMS substrate 110 provides a base upon which the chitosan layer 105 is deposited.

The bilayer film 100 can comprise a chitosan layer 105 having a thickness of approximately 10 micrometers disposed on a PDMS substrate 110 having a thickness of approximately 200 micrometers. In some cases, the chitosan layer 105 can have a thickness in a range of about 5 micrometers to about 20 micrometers, and the PDMS substrate 110 can have a thickness in a range of about 100 micrometers to about 300 micrometers. The disclosed values are exemplary only, and other values are contemplated within the scope of the present disclosure.

The chitosan layer 105 can comprise chitosan having a medium molecular weight in a range of 190,000 to 310,000 Da with a degree of deacetylation of 75-85%. In some cases, the molecular weight can be in a range of about 150,000 Da to about 350,000 Da, and the degree of deacetylation can be in a range of about 70% to about 90%. The disclosed values are exemplary only, and other values are contemplated within the scope of the present disclosure.

The chitosan layer 105 can comprise interface-confined water molecules entrapped within amorphous hydrogen-bonded domains of the chitosan layer 105. The interface-confined water molecules can comprise freezing bound water held by hydrogen bonds between amine and hydroxyl groups of the chitosan layer 105. The freezing bound water can be confined within an amorphous region between chitosan and bulk water, held by hydrogen bonds. As a result of relatively weak binding forces, the freezing bound water can remain susceptible to crystallization despite being bound. The interface-confined water molecules can be referred to herein as freezing bound water that exhibits a cold crystallization exotherm at a sub-zero temperature.

The chitosan layer 105 can exhibit an elastic modulus that is reduced relative to an unsoftened chitosan film lacking the interface-confined water molecules. As described previously, the elastic modulus of chitosan films can decrease from values in a range of about 80 MPa to about 95 MPa for unsoftened films to values in a range of about 30 MPa to about 35 MPa or less for hydro-softened films. The chitosan layer 105 can be free of apparent surface moisture while exhibiting the reduced elastic modulus.

The chitosan layer 105 can exhibit a chitosan purity of approximately 86.4% when calculated at the film-on-substrate scale including PDMS and TEOS contributions. In some cases, the chitosan layer 105 can exhibit a chitosan purity of approximately 97.3% when calculated for the film-only case with TEOS precursor. In some aspects, the chitosan layer 105 can have a chitosan purity of at least 75 weight percent. In some aspects, the chitosan layer 105 can have a chitosan purity of at least 80 weight percent. The disclosed values are exemplary only, and other values are contemplated within the scope of the present disclosure.

The bilayer film 100 can be characterized as a hydro-softened chitosan film. The PDMS substrate 110 can comprise poly(dimethylsiloxane), and the chitosan layer 105 can be disposed on the PDMS substrate 110. The chitosan layer 105 can comprise a polysaccharide layer comprising amorphous hydrogen-bonded domains. The amorphous hydrogen-bonded domains can comprise interface-confined water molecules held by hydrogen bonds within the polysaccharide layer. The polysaccharide layer can exhibit a reduced elastic modulus relative to an unsoftened polysaccharide film of the same composition lacking the interface-confined water molecules. The polysaccharide layer can be free of apparent surface moisture. The polysaccharide layer can comprise chitosan.

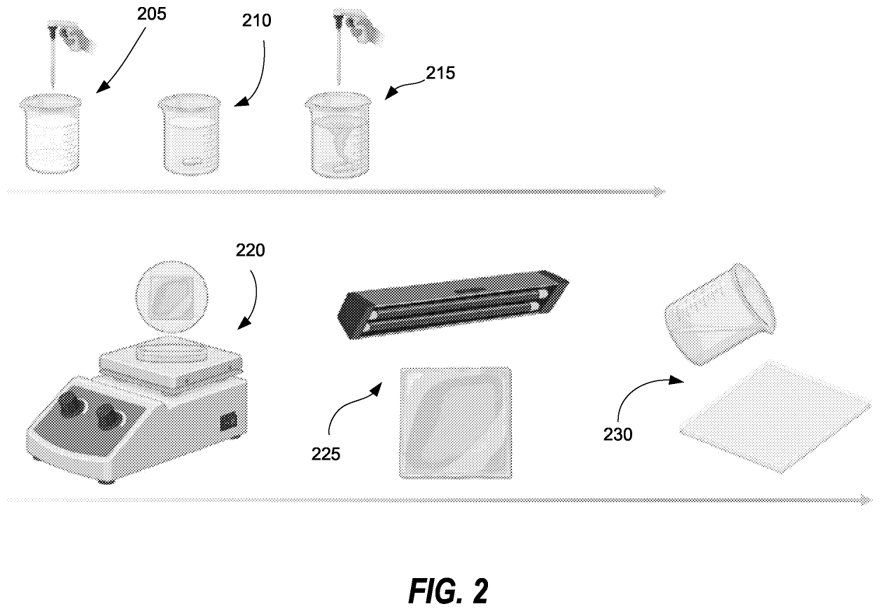

FIG. 2 illustrates a fabrication process 200 for producing hydro-softened chitosan films according to examples of the disclosed technology. The fabrication process 200 can include a series of steps that enable the formation of a chitosan layer having interface-confined water molecules entrapped within amorphous hydrogen-bonded domains of the chitosan layer.

At a step 205, a chitosan solution can be prepared by dissolving and protonating chitosan in a dilute acidic solution. The dilute acidic solution can comprise 5.88 mL of 1 M HCl and 100 mL of deionized water per gram of chitosan. The dilute acidic solution can be prepared based on a stoichiometric ratio between available protons and chitosan amine groups. In some cases, the dilute acidic solution can comprise about 5 mL to about 7 mL of 1 M HCl and about 80 mL to about 120 mL of deionized water per gram of chitosan. The disclosed values are exemplary only, and other values are contemplated within the scope of the present disclosure.

At a step 210, the chitosan solution can be stirred at room temperature until fully homogeneous. The stirring can continue until the chitosan is fully dissolved and protonated in the dilute acidic solution.

At a step 215, a silane precursor can be added to the chitosan solution to form a silanized chitosan sol. The silane precursor can comprise tetraethyl orthosilicate (TEOS). The TEOS can be added at a volume of 260 microliters per gram of chitosan to achieve a degree of substitution of about 40%. In some cases, the TEOS can be added at a volume in a range of about 200 microliters to about 350 microliters per gram of chitosan to achieve a degree of substitution in a range of about 30% to about 50%. The disclosed values are exemplary only, and other values are contemplated within the scope of the present disclosure. The mixture can be stirred to ensure complete hydrolysis and precursor activation. The silanized chitosan sol can be referred to herein as a hydrolyzed chitosan solution.

At a step 220, a polymer substrate can be prepared. The polymer substrate can comprise poly(dimethylsiloxane) (PDMS). The PDMS substrate can be prepared by mixing a base and a curing agent at a 10:1 ratio by weight. Silicon wafers can be cleaned with acetone, isopropanol, and deionized water prior to spin-coating. The PDMS can be spin-coated onto the cleaned silicon wafers at 800 rpm for 60 seconds to yield a dry film thickness of approximately 200 micrometers. In some cases, the spin-coating speed can be in a range of about 600 rpm to about 1000 rpm, and the dry film thickness can be in a range of about 100 micrometers to about 300 micrometers. The disclosed values are exemplary only, and other values are contemplated within the scope of the present disclosure.

The polymer substrate can be cured at a curing temperature. The curing temperature can be selected to control a stiffness of the polymer substrate. The PDMS substrate can be cured at temperatures including room temperature, 40 degrees Celsius, 80 degrees Celsius, 120 degrees Celsius, and 160 degrees Celsius to induce varying network densities and steric environments. In some cases, the curing temperature can be at least 100 degrees Celsius. In some cases, the curing temperature can be in a range of about 20 degrees Celsius to about 180 degrees Celsius. The disclosed values are exemplary only, and other values are contemplated within the scope of the present disclosure. Increasing the stiffness of the polymer substrate can increase a volume of the interface-confined water molecules in the chitosan layer. The accumulation of steric hindrance arising from the hardening of the substrate at different temperatures can alter water retention within the amine-hydroxyl-rich amorphous domains of chitosan.

Following thermal curing, a surface of the cured polymer substrate can be treated to introduce hydroxyl groups on the surface. Treating the surface of the cured polymer substrate can comprise exposing the surface to UV-ozone treatment. The UV-ozone treatment can be performed for 2 hours to introduce surface hydroxyl groups. In some cases, the UV-ozone treatment can be performed for a duration in a range of about 1 hour to about 4 hours. The disclosed values are exemplary only, and other values are contemplated within the scope of the present disclosure. The UV-ozone treatment can introduce hydroxyl and carboxyl functionalities to the PDMS surface.

At a step 225, the silanized chitosan sol can be deposited onto the treated surface of the cured polymer substrate. Depositing the silanized chitosan sol can comprise spin-coating the silanized chitosan sol onto the treated surface. The silanized chitosan sol can be spin-coated onto the activated PDMS surfaces at 1200 rpm for 60 seconds. In some cases, the spin-coating speed can be in a range of about 1000 rpm to about 1500 rpm. The disclosed values are exemplary only, and other values are contemplated within the scope of the present disclosure. The spin-coating can enable condensation reactions between chitosan and PDMS hydroxyls.

At a step 230, condensation of the silanized chitosan sol on the treated surface can be allowed to form a chitosan layer having interface-confined water molecules entrapped within amorphous hydrogen-bonded domains of the chitosan layer. The condensation reaction between the chitosan sol and surface hydroxyls can progress over approximately 25 to 35 minutes at room temperature. In some cases, the condensation can progress over a duration in a range of about 20 minutes to about 45 minutes. The disclosed values are exemplary only, and other values are contemplated within the scope of the present disclosure. The condensation reaction can expel solvent and form the chitosan film. Interfacial steric effects can dictate the extent of entropic confinement during the condensation process.

As described previously, the curing temperature can be selected to control a stiffness of the polymer substrate, and increasing the stiffness of the polymer substrate can increase a volume of the interface-confined water molecules in the chitosan layer. When steric hindrance impedes the condensation reaction, the sol coating process can become less efficient at promoting the condensation of the remnant water solvent, resulting in an increased volume of interface-confined water upon drying. The resulting chitosan films can exhibit uniform thickness and smooth surface morphology.

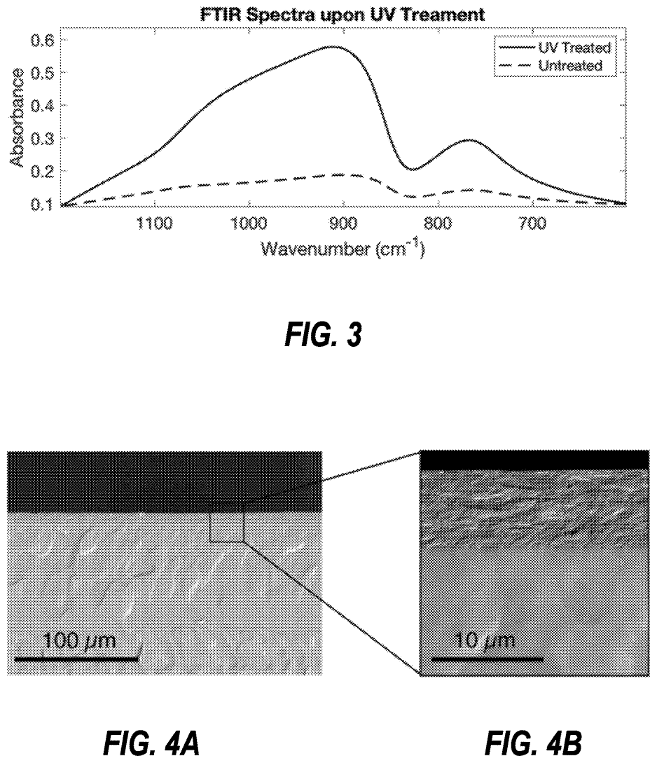

FIG. 3 illustrates Fourier transform infrared (FTIR) spectra comparing UV treated and untreated poly(dimethylsiloxane) (PDMS) samples according to examples of the disclosed technology. The FTIR spectra can confirm the introduction of hydroxyl and carboxyl functional groups on the PDMS surface following UV-ozone (UV-O₃) treatment. The UV treated curve can exhibit significantly higher absorbance values compared to the untreated curve across the measured spectral range. The UV treated curve can show a broad absorption feature with a peak near 900 cm⁻¹, while the untreated curve can remain relatively flat throughout the spectral range. The introduction of hydroxyl groups to the PDMS surface can result in reduced surface energy upon coating. Water contact angle measurements before and after UV-O₃ treatment can reveal a decrease from approximately 105 degrees to approximately 55 degrees, indicating a transition from a hydrophobic to a hydrophilic surface. In some cases, the water contact angle before UV-O₃ treatment can be in a range of about 100 degrees to about 110 degrees, and the water contact angle after UV-O₃ treatment can be in a range of about 50 degrees to about 60 degrees. The disclosed values are exemplary only, and other values are contemplated within the scope of the present disclosure.

FIG. 4A illustrates a cross-sectional scanning electron microscope (SEM) image of a bilayer film according to examples of the disclosed technology. The cross-sectional SEM image can show a layered structure with a smooth upper region corresponding to a chitosan layer and a textured lower region corresponding to a PDMS substrate. The chitosan layer can have a thickness of approximately 10 micrometers disposed on a PDMS substrate having a thickness of approximately 200 micrometers. In some cases, the chitosan layer can have a thickness in a range of about 5 micrometers to about 20 micrometers, and the PDMS substrate can have a thickness in a range of about 100 micrometers to about 300 micrometers. The disclosed values are exemplary only, and other values are contemplated within the scope of the present disclosure. The chitosan layer can remain structurally intact, with a well-defined interface between the chitosan film and the underlying PDMS substrate. The resulting chitosan films can exhibit uniform thickness and smooth surface morphology in cross-sectional SEM analysis.

FIG. 4B illustrates a magnified cross-sectional view of an interface region of the bilayer film of FIG. 4A according to examples of the disclosed technology. The magnified view can show the interface region between the smooth chitosan layer and the textured PDMS substrate in greater detail. The magnified view can highlight the distinct morphology of the hydro-softened chitosan film, demonstrating a continuous structure. The distinct boundary between the chitosan and PDMS layers can be visible in the magnified cross-sectional view. Compositional consistency across the interface can be confirmed by Energy-Dispersive X-ray Spectroscopy (EDS).

Samples can be prepared for SEM analysis by immersion in 70% v/v ethanol for approximately 15 minutes followed by dehydration at approximately 40 degrees Celsius. In some cases, the immersion time can be in a range of about 10 minutes to about 20 minutes, and the dehydration temperature can be in a range of about 35 degrees Celsius to about 45 degrees Celsius. The disclosed values are exemplary only, and other values are contemplated within the scope of the present disclosure. The immersion and dehydration can minimize charging artifacts and improve imaging stability during SEM observation. Following dehydration, samples can be sputter-coated with a thin layer of gold for approximately 45 seconds to enhance conductivity during SEM observation. In some cases, the sputter coating duration can be in a range of about 30 seconds to about 60 seconds. The disclosed values are exemplary only, and other values are contemplated within the scope of the present disclosure. Cross-sectional views can be prepared by freeze-fracturing the samples in liquid nitrogen. The SEM can be operated at an operating voltage of approximately 10 kV. In some cases, the operating voltage can be in a range of about 5 kV to about 15 kV. The disclosed values are exemplary only, and other values are contemplated within the scope of the present disclosure.

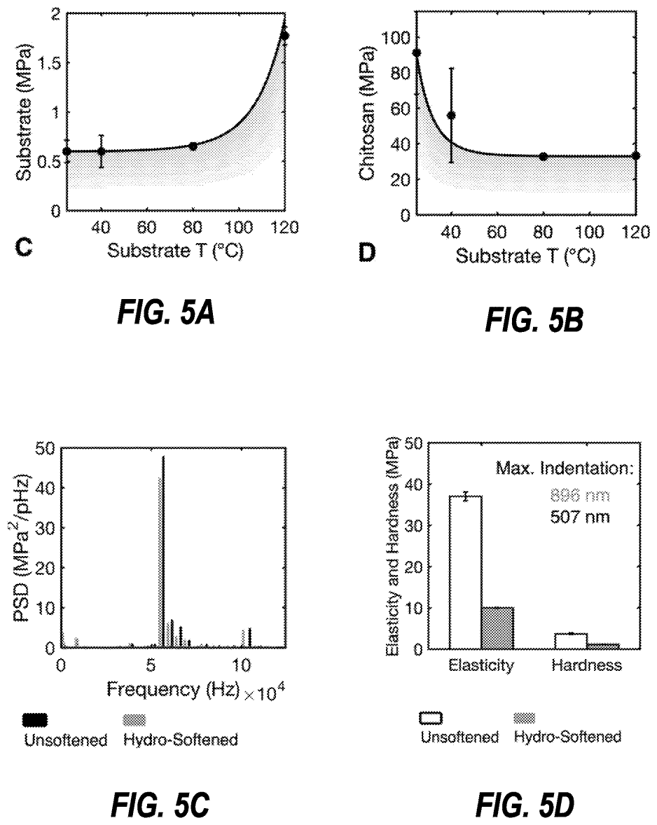

FIGS. 5A-5D illustrate mechanical property data for hydro-softened and unsoftened chitosan films according to examples of the disclosed technology. The mechanical properties of the chitosan films can be characterized through tensile testing and nanoindentation measurements to evaluate the effects of hydro-softening on elastic modulus and hardness.

FIG. 5A illustrates substrate elastic modulus as a function of substrate processing temperature. The elastic modulus of the PDMS substrate can increase from approximately 0.6 MPa at room temperature to approximately 2 MPa as the curing temperature increases to 160 degrees Celsius. In some cases, the elastic modulus of the PDMS substrate can increase from a value in a range of about 0.5 MPa to about 0.7 MPa at room temperature to a value in a range of about 1.8 MPa to about 2.2 MPa at elevated curing temperatures. The disclosed values are exemplary only, and other values are contemplated within the scope of the present disclosure. The evolution of PDMS elastic modulus as a function of curing temperature can be modeled using the exponential integral Eᵢ(x), which captures the accumulation of steric effects arising from the progressive hardening of the PDMS substrate.

FIG. 5B illustrates chitosan elastic modulus as a function of substrate processing temperature. The elastic modulus of the chitosan layer can decrease from approximately 91 MPa to approximately 35 MPa as the PDMS substrate curing temperature increases from room temperature to 120 degrees Celsius. In some cases, the elastic modulus of the chitosan layer can decrease from a value in a range of about 85 MPa to about 95 MPa at room temperature substrate curing to a value in a range of about 30 MPa to about 40 MPa at elevated substrate curing temperatures. The disclosed values are exemplary only, and other values are contemplated within the scope of the present disclosure. The evolution of chitosan elastic modulus as a function of PDMS curing temperature can be modeled using the complementary exponential integral E₁(x), which captures the decay process driven by accumulated steric resistance during condensation. The complementary relationship between the exponential integrals Eᵢ(x) and E₁(x) captures how temperature-driven steric accumulation in the PDMS substrate triggers a corresponding reduction in the elastic modulus of the chitosan layer.

As described previously, the chitosan layer can exhibit an elastic modulus of about 35 MPa or less. The chitosan layer can exhibit a softness, defined as an inverse of the elastic modulus, of at least 10⁻⁸ Pa⁻¹. The chitosan layer can have a chitosan purity of at least 75 weight percent. In some cases, the chitosan layer can have a chitosan purity of at least 80 weight percent.

Tensile properties can be measured with the films subject to a constant deformation rate of 1 mm per minute. Samples can be cut into rectangular shapes with ratios following standard testing protocols. The elastic modulus can be determined from the slope of the stress-strain response within the initial 3% strain range, selected to ensure that the analysis remains within the linear-elastic regime of the material. In some cases, the deformation rate can be in a range of about 0.5 mm per minute to about 2 mm per minute, and the strain range for elastic modulus determination can be in a range of about 2% to about 5%. The disclosed values are exemplary only, and other values are contemplated within the scope of the present disclosure.

FIG. 5C illustrates power spectral density (PSD) comparing unsoftened and hydro-softened chitosan. PSD analysis of the residual signal from tensile stress-strain curves can reveal a marked reduction in high-frequency mechanical fluctuations for hydro-softened films relative to unsoftened controls. The attenuation beyond 5×10⁴ Hz can indicate dampening of local mechanical fluctuations and enhanced molecular-level energy dissipation. The suppression of high-frequency fluctuations can reflect a minimized Gibbs free energy and lowered disjoining pressure, thereby stabilizing the hydro-softened matrix and reducing variance in mechanical response.

FIG. 5D illustrates elasticity and hardness measurements for unsoftened and hydro-softened chitosan films obtained through nanoindentation. Nanoindentation tests can be conducted with a 10-micron conospherical probe at a constant 25 microNewton load with probing maximum depth controlled to be within the thickness of the chitosan film. In some cases, the load can be in a range of about 20 microNewtons to about 30 microNewtons. The disclosed values are exemplary only, and other values are contemplated within the scope of the present disclosure. The nanoindentation tests can be conducted solely on and within the chitosan layer to eliminate coupling effects that can arise due to the substrate.

The hydro-softened chitosan layer can exhibit a nanoindentation elastic modulus of approximately 11.4 MPa and hardness of approximately 1.14 MPa, compared to 37 MPa and 3.73 MPa for unsoftened chitosan. In some cases, the nanoindentation elastic modulus of the hydro-softened chitosan layer can be in a range of about 10 MPa to about 13 MPa, and the hardness can be in a range of about 1 MPa to about 1.5 MPa. In some cases, the nanoindentation elastic modulus of the unsoftened chitosan layer can be in a range of about 35 MPa to about 40 MPa, and the hardness can be in a range of about 3.5 MPa to about 4 MPa. The disclosed values are exemplary only, and other values are contemplated within the scope of the present disclosure. The reduction in mechanical resistance can be accompanied by an increase in maximum indentation depth, from 507 nm for unsoftened chitosan to 896 nm for hydro-softened chitosan when maintaining the same load during tests. The increased indentation depth under identical load conditions can demonstrate enhanced compliance resulting from confined water within the polymer matrix.

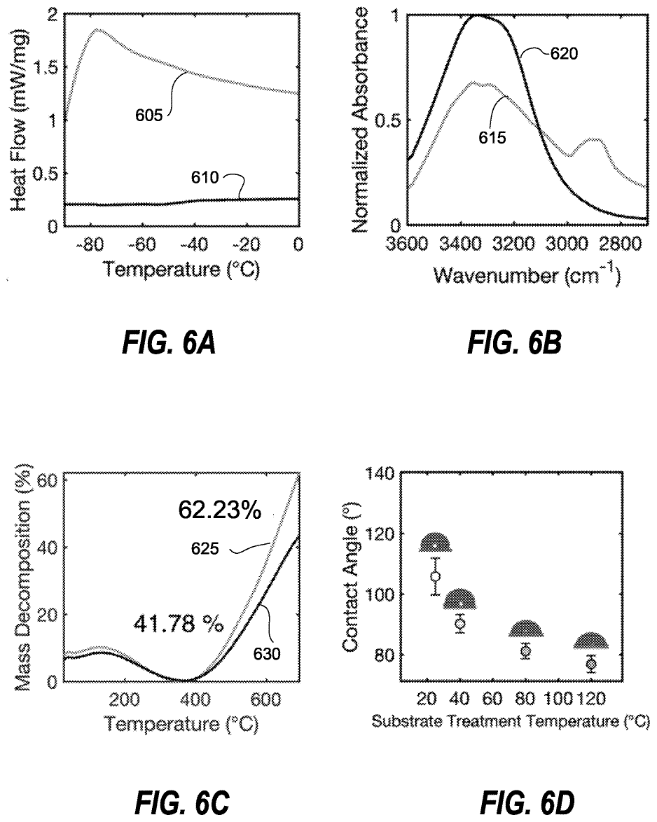

FIGS. 6A-6D illustrate thermophysical and spectroscopic characterization data comparing hydro-softened and unsoftened chitosan films according to examples of the disclosed technology. The presence of interface-confined water in hydro-softened chitosan films can be confirmed through differential scanning calorimetry (DSC), Fourier transform infrared (FTIR) spectroscopy, thermogravimetric analysis (TGA), and water contact angle measurements.

FIG. 6A illustrates differential scanning calorimetry (DSC) data comparing hydro-softened and unsoftened chitosan films. A hydro-softened chitosan DSC curve 605 can exhibit a cold crystallization exotherm peak at approximately −74 degrees Celsius with a heat flow of approximately 1.8 mW/mg. In some cases, the cold crystallization exotherm peak can occur at a temperature in a range of about −80 degrees Celsius to about −70 degrees Celsius, and the heat flow can be in a range of about 1.5 mW/mg to about 2.0 mW/mg. The disclosed values are exemplary only, and other values are contemplated within the scope of the present disclosure. An unsoftened chitosan DSC curve 610 can maintain a consistent baseline reading of approximately 0.2 mW/mg without a cold crystallization peak. In some cases, the baseline reading can be in a range of about 0.1 mW/mg to about 0.3 mW/mg. The disclosed values are exemplary only, and other values are contemplated within the scope of the present disclosure. The interface-confined water molecules can be referred to herein as freezing bound water that exhibits a cold crystallization exotherm at a sub-zero temperature when measured by differential scanning calorimetry.

The cold crystallization observed in the hydro-softened chitosan DSC curve 605 can result from an arrangement of freezable water molecules in the amine-hydroxyl amorphous region into an orderly crystalline structure upon heating. Cold crystallization can be attributed to the reordering of tightly confined, nonfreezing water domains upon heating following prior suppression of crystallization upon cooling. Non-freezing bound water does not undergo crystallization; therefore, in the absence of hydro-softening, the exothermic peak would not be observed in the unsoftened chitosan DSC curve 610.

DSC measurements can be performed with an isothermal equilibration at −90 degrees Celsius for 8 minutes followed by a heating ramp from −90 degrees Celsius to 80 degrees Celsius at 20 degrees Celsius per minute. In some cases, the isothermal equilibration can be performed for a duration in a range of about 5 minutes to about 10 minutes, and the heating rate can be in a range of about 15 degrees Celsius per minute to about 25 degrees Celsius per minute. The disclosed values are exemplary only, and other values are contemplated within the scope of the present disclosure.

FIG. 6B illustrates Fourier transform infrared (FTIR) spectroscopy data comparing hydro-softened and unsoftened chitosan films. A hydro-softened chitosan FTIR spectrum 615 can exhibit a distinct O-H absorption peak at approximately 3400 cm⁻¹ superimposed on a broad amine-hydroxyl band between 3200 and 3500 cm⁻¹. The hydro-softened chitosan FTIR spectrum 615 can exhibit a distinct peak at approximately 2900 cm⁻¹ in addition to the O—H peak at 3400 cm⁻¹, indicating tightly confined hydroxyl arrangements. The additional peak at approximately 2900 cm⁻¹ can be consistent with altered hydrogen bonding network within chitosan. An unsoftened chitosan FTIR spectrum 620 can show a different absorption profile in the same spectral region.

The hydro-softened chitosan FTIR spectrum 615 can show a more prominent H—O—H bending near 1650 cm⁻¹ and more pronounced peaks in the C—O stretching region of 1000 to 1200 cm⁻¹. The distinct peak at 3400 cm⁻¹ superimposed on the broad amine-hydroxyl band can arise from the confinement of water molecules bound to the polymer backbone, which exhibits a more defined, localized vibrational stretching. The chitosan layer can be referred to herein as exhibiting a distinct O—H absorption peak at approximately 3400 cm⁻¹ superimposed on a broad amine-hydroxyl band between 3200 and 3500 cm⁻¹ when measured by Fourier transform infrared spectroscopy.

FTIR spectra can be collected over 32 scans in the range of 4000 to 800 cm⁻¹ at a resolution of 4 cm⁻¹. In some cases, the number of scans can be in a range of about 16 to about 64, and the resolution can be in a range of about 2 cm⁻¹ to about 8 cm⁻¹. The disclosed values are exemplary only, and other values are contemplated within the scope of the present disclosure.

FIG. 6C illustrates thermogravimetric analysis (TGA) data comparing hydro-softened and unsoftened chitosan films. A hydro-softened chitosan TGA curve 625 can show a relative mass decomposition of approximately 62% between 100 and 600 degrees Celsius. An unsoftened chitosan TGA curve 630 can show a relative mass decomposition of approximately 42% over the same temperature range. In some cases, the mass decomposition of the hydro-softened chitosan can be in a range of about 58% to about 66%, and the mass decomposition of the unsoftened chitosan can be in a range of about 38% to about 46%. The disclosed values are exemplary only, and other values are contemplated within the scope of the present disclosure.

The polysaccharide layer can be referred to herein as exhibiting a mass decomposition above 100 degrees Celsius that is greater than a mass decomposition of the unsoftened polysaccharide film, as measured by thermogravimetric analysis. To exclude the contributions from loosely bound water, which evaporates at temperatures below 100 degrees Celsius, relative mass decompositions can be analyzed over a temperature range of 100 to 600 degrees Celsius. The greater mass decomposition in the hydro-softened chitosan TGA curve 625 compared to the unsoftened chitosan TGA curve 630 can indicate the presence of tightly bound water that persists beyond the boiling point of unbound water.

TGA can be conducted using a 20 degrees Celsius per minute linear ramp from 25 to 700 degrees Celsius under nitrogen atmosphere. In some cases, the heating rate can be in a range of about 15 degrees Celsius per minute to about 25 degrees Celsius per minute, and the final temperature can be in a range of about 600 degrees Celsius to about 800 degrees Celsius. The disclosed values are exemplary only, and other values are contemplated within the scope of the present disclosure.

FIG. 6D illustrates water contact angle measurements as a function of substrate treatment temperature according to examples of the disclosed technology. The water contact angle of the chitosan layer can decrease from approximately 104 degrees to approximately 78 degrees upon hydro-softening. In some cases, the water contact angle before hydro-softening can be in a range of about 100 degrees to about 108 degrees, and the water contact angle after hydro-softening can be in a range of about 74 degrees to about 82 degrees. The disclosed values are exemplary only, and other values are contemplated within the scope of the present disclosure.

The polysaccharide layer can be referred to herein as exhibiting a water contact angle that decreases with increasing hydro-softening, indicating increased surface hydrophilicity relative to the unsoftened polysaccharide film. The decreasing contact angle can indicate a shift in the location of polar molecules on the chitosan surface. The balance of interfacial water states can influence the density of accessible polar groups, thereby shaping surface hydrophilicity. The structured hydration layer can present a more polar interface to the contacting droplet on the film-to-air interface, increasing hydrophilicity.

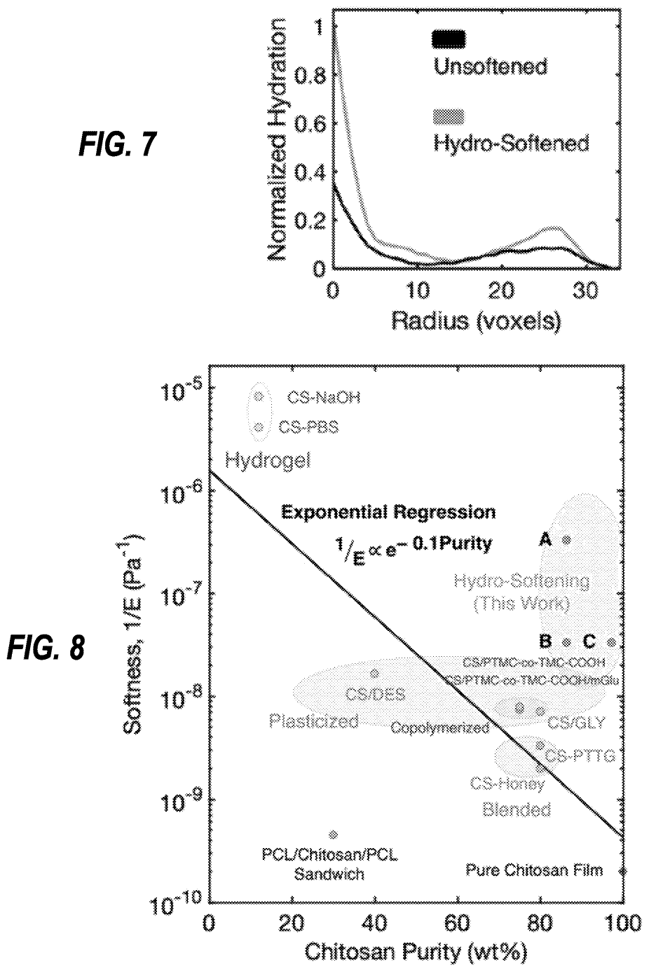

FIG. 7 illustrates normalized hydration as a function of radius in voxels comparing unsoftened and hydro-softened chitosan according to examples of the disclosed technology. The radial decay profiles can be extracted from voxel-based hydration maps to characterize the spatial distribution of hydration around the chitosan polymer chain.

The unsoftened chitosan curve can exhibit a peak near zero voxels reaching approximately 1.0 normalized hydration, followed by a decay as the radius increases. The hydro-softened chitosan curve can show a similar peak near zero voxels, with both curves converging toward zero as the radius increases beyond approximately 10 voxels. The hydro-softened chitosan can exhibit a tighter decay length relative to unsoftened chitosan, indicating more localized structuring of hydration clusters. In some cases, the decay length of hydro-softened chitosan can be approximately 1.56 Angstroms, and the decay length of unsoftened chitosan can be approximately 1.79 Angstroms. In some cases, the decay length of hydro-softened chitosan can be in a range of about 1.4 Angstroms to about 1.7 Angstroms, and the decay length of unsoftened chitosan can be in a range of about 1.6 Angstroms to about 2.0 Angstroms. The disclosed values are exemplary only, and other values are contemplated within the scope of the present disclosure.

The hydro-softened chitosan can exhibit tighter and more symmetric directional decay profiles, indicative of entropically structured hydration. The Shannon entropy of the hydration field can decrease from approximately 2.1 in unsoftened films to approximately 1.6 in hydro-softened films. In some cases, the Shannon entropy of unsoftened films can be in a range of about 1.9 to about 2.3, and the Shannon entropy of hydro-softened films can be in a range of about 1.4 to about 1.8. The disclosed values are exemplary only, and other values are contemplated within the scope of the present disclosure. The reduction in Shannon entropy can reflect a measurable loss in configurational disorder and can confirm the emergence of spatially ordered, sterically stabilized hydration domains.

The radial hydration profiles can demonstrate that steric confinement alters the hydration landscape around the chitosan chain upon hydro-softening. In the unsoftened state, hydration can be diffusely distributed, with no preferential accumulation. In contrast, the hydro-softened configuration can exhibit anisotropic hydration clustering, particularly in regions sterically confined to the substrate interface. These confined zones can display locally elevated hydration values, consistent with a network orientation that favors the retention of high-energy water. The redistribution can reflect a reduction in configurational entropy, effectively forcing water into constrained, less favorable states.

The unsoftened chitosan can primarily host unbound and weakly bound water, with minimal formation of tightly bound hydration shells. In contrast, the hydro-softened chitosan can exhibit a significant increase in tightly bound hydration clusters, particularly in substrate-adjacent regions. The transition in hydration regime can reflect how water molecules become transiently entrapped in constrained regions when unable to diffuse freely upon hydro-softening.

FIG. 8 illustrates softness as a function of chitosan purity for various processing methods according to examples of the disclosed technology. The softness can be defined as the inverse of the elastic modulus and can be expressed in units of Pa⁻¹. The chitosan purity can be expressed in weight percent. The semi-logarithmic plot can present the relationship between softness and chitosan purity across different processing approaches.

The plot can include an exponential regression boundary representing the softness-purity trade-off in conventional softening mechanisms. The exponential regression can follow the relationship 1/E∝e^{-0.1×Purity}, where E represents the elastic modulus and Purity represents the chitosan purity in weight percent. The exponential regression boundary can delineate the conventional trade-off between achieving mechanical softness and maintaining compositional purity in chitosan materials.

The plot can include data points for various processing methods including hydrogel formulations, plasticized formulations, copolymerized formulations, and blended formulations. Hydrogel formulations can include CS-NaOH and CS-PBS, which can exhibit high softness but low chitosan purity of approximately 12 weight percent. Plasticized formulations can include CS-DES with a chitosan purity of approximately 40 weight percent and CS-GLY with a chitosan purity of approximately 80 weight percent. Copolymerized formulations can include CS/PTMC-co-TMC-COOH and CS/PTMC-co-TMC-COOH/mGlu with a chitosan purity of approximately 75 weight percent. Blended formulations can include CS-PTTG and CS-Honey with a chitosan purity of approximately 80 weight percent. A pure chitosan film data point can appear at approximately 100 weight percent purity with the lowest softness value.

The plot can include three data points designated A, B, and C representing the hydro-softening approach. Data point A can assume compositional purity when water is localized to the film-substrate interface. Data point B can assume compositional purity when confinement is within central polymer chains. Data point C can assume compositional purity when water is within the central chain and the precursor. These data points can reside above the exponential regression boundary, indicating that hydro-softening can overcome the established purity-softness trade-off.

The hydro-softened chitosan films can exhibit softness values of approximately 10⁻⁷ to 10⁻⁸ Pa⁻¹ while maintaining chitosan purity between approximately 80 and 100 weight percent. In some cases, the softness of hydro-softened chitosan films can be in a range of about 10⁻⁸ Pa⁻¹ to about 10⁻⁶ Pa⁻¹, and the chitosan purity can be in a range of about 75 weight percent to about 100 weight percent. The disclosed values are exemplary only, and other values are contemplated within the scope of the present disclosure.

The resulting hydro-softened films can be neither plasticized nor swollen, but instead can represent a thermodynamically-driven, water-mediated response. The hydro-softening mechanism can preserve a level of compositional purity that can be compromised in conventional methods of softening. The chitosan layer can be referred to herein as exhibiting a softness, defined as an inverse of the elastic modulus, of at least 10⁻⁸ Pa⁻¹.

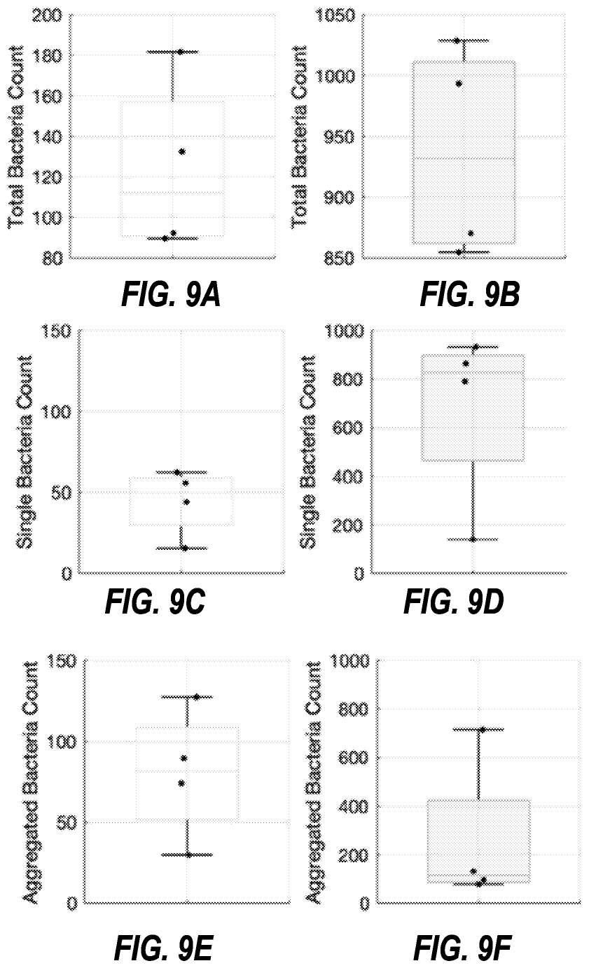

FIGS. 9A-9F illustrate bacterial count data across different measurement categories according to examples of the disclosed technology. The bacterial adhesion analysis can characterize the enhanced adhesion properties of hydro-softened chitosan films relative to unsoftened chitosan films.

Bacterial adhesion assays can be performed using Staphylococcus epidermidis as a model organism. Prior to bacterial exposure, hydro-softened and unsoftened chitosan films can be mounted to isolate one surface, ensuring that only the side of interest is exposed to the bacterial suspension. The films can be placed in culture plates and incubated with a bacterial suspension prepared in tryptic soy broth (TSB). In some cases, the bacterial suspension can have an optical density of approximately 0.3, corresponding to approximately 5×10⁷ cells/mL. In some cases, the optical density can be in a range of about 0.2 to about 0.4, and the cell concentration can be in a range of about 1×10⁷ cells/mL to about 1×10⁸ cells/mL. The disclosed values are exemplary only, and other values are contemplated within the scope of the present disclosure.

Incubation can be performed at approximately 37 degrees Celsius for approximately 24 hours under static and humidified conditions. In some cases, the incubation temperature can be in a range of about 35 degrees Celsius to about 39 degrees Celsius, and the incubation duration can be in a range of about 12 hours to about 48 hours. The disclosed values are exemplary only, and other values are contemplated within the scope of the present disclosure. Following incubation, samples can be rinsed with phosphate-buffered saline (PBS) to remove nonadherent bacteria prior to scanning electron microscope (SEM) imaging.

Bacterial adhesion can be quantified through a multistep image analysis pipeline designed to resolve both single-cell and aggregated adhesion outcomes. SEM images can be preprocessed using adaptive histogram equalization to enhance local contrast, followed by Gaussian filtering and background correction to minimize artifacts. Adaptive thresholding and area-based filtering can isolate bacterial regions from the background. Watershed segmentation and distance transformation can delineate overlapping cells within clusters, enabling connected-component analysis and the extraction of morphological features. Bacteria can be classified as either single cells or aggregates based on shape metrics, providing a morphology-resolved quantification of adhesion.

FIG. 9A illustrates total bacteria count data for a first sample condition corresponding to unsoftened chitosan films. FIG. 9B illustrates total bacteria count data for a second sample condition corresponding to hydro-softened chitosan films. The hydro-softened chitosan films can exhibit over 5-fold greater adhesion compared to unsoftened chitosan films. In some cases, hydro-softened films can support an average of approximately 990 total adhered bacteria, while unsoftened films can average approximately 180 total adhered bacteria. In some cases, the total adhered bacteria on hydro-softened films can be in a range of about 850 to about 1050, and the total adhered bacteria on unsoftened films can be in a range of about 80 to about 200. The disclosed values are exemplary only, and other values are contemplated within the scope of the present disclosure.

FIG. 9C illustrates single bacteria count data for a first sample condition corresponding to unsoftened chitosan films. FIG. 9D illustrates single bacteria count data for a second sample condition corresponding to hydro-softened chitosan films. The hydro-softened chitosan films can exhibit increased single-cell bacterial attachment rather than localized colonization. The connected-component analysis can reveal a marked increase in single-cell adhesion on hydro-softened films compared to unsoftened films. The shift toward predominantly single bacterial attachment on hydro-softened chitosan can indicate uniform interfacial engagement rather than aggregate formation.

FIG. 9E illustrates aggregated bacteria count data for a first sample condition corresponding to unsoftened chitosan films. FIG. 9F illustrates aggregated bacteria count data for a second sample condition corresponding to hydro-softened chitosan films. The aggregated bacteria count data can demonstrate that hydro-softening promotes a shift toward a more disperse, individual attachment pattern. Unsoftened chitosan films can exhibit sparse adhesion distribution, whereas hydro-softened chitosan films can show markedly greater surface coverage with predominantly single-cell attachment.

The enhanced bacterial adhesion on hydro-softened chitosan films can result from the reduced elastic modulus and reduced interfacial energy of the hydro-softened films. The hydro-softening mechanism can lower the threshold for bacterial adhesion by altering the energetic landscape of initial contact. The hydro-softened chitosan films can provide a platform for developing adhesion-tunable coatings in applications including bio-adhesive coatings, wound dressings, and biomedical interfaces.

The disclosed technology can be further understood according to the following clauses:

Clause 1: A hydro-softened chitosan film, comprising: a chitosan layer comprising interface-confined water molecules entrapped within amorphous hydrogen-bonded domains of the chitosan layer, wherein the interface-confined water molecules comprise freezing bound water held by hydrogen bonds between amine and hydroxyl groups of the chitosan layer; wherein the chitosan layer exhibits an elastic modulus that is reduced relative to an unsoftened chitosan film lacking the interface-confined water molecules; and wherein the chitosan layer is free of apparent surface moisture.

Clause 2: The hydro-softened chitosan film of clause 1, wherein the chitosan layer has a chitosan purity of at least 75 weight percent.

Clause 3: The hydro-softened chitosan film of clause 1, wherein the chitosan layer has a chitosan purity of at least 80 weight percent.

Clause 4: The hydro-softened chitosan film of clause 1, wherein the chitosan layer exhibits a softness, defined as an inverse of the elastic modulus, of at least 10⁻⁸ Pa⁻¹.

Clause 5: The hydro-softened chitosan film of clause 1, wherein the chitosan layer exhibits an elastic modulus of about 35 MPa or less.

Clause 6: The hydro-softened chitosan film of clause 1, wherein the interface-confined water molecules exhibit a cold crystallization exotherm at a sub-zero temperature when measured by differential scanning calorimetry.

Clause 7: The hydro-softened chitosan film of clause 1, wherein the chitosan layer exhibits a distinct O-H absorption peak at approximately 3400 cm⁻¹ superimposed on a broad amine-hydroxyl band between 3200 and 3500 cm⁻¹ when measured by Fourier transform infrared spectroscopy.

Clause 8: The hydro-softened chitosan film of clause 1, further comprising a poly(dimethylsiloxane) (PDMS) substrate, wherein the chitosan layer is disposed on the PDMS substrate.

Clause 9: A method of fabricating a hydro-softened chitosan film, comprising: preparing a chitosan solution by dissolving and protonating chitosan in a dilute acidic solution; adding a silane precursor to the chitosan solution to form a silanized chitosan sol; preparing a polymer substrate; curing the polymer substrate at a curing temperature; treating a surface of the cured polymer substrate to introduce hydroxyl groups on the surface; depositing the silanized chitosan sol onto the treated surface of the cured polymer substrate; and allowing condensation of the silanized chitosan sol on the treated surface to form a chitosan layer having interface-confined water molecules entrapped within amorphous hydrogen-bonded domains of the chitosan layer.

Clause 10: The method of clause 9, wherein the silane precursor comprises tetraethyl orthosilicate (TEOS).

Clause 11: The method of clause 9, wherein the silane precursor is added to achieve a degree of substitution of about 40%.

Clause 12: The method of clause 9, wherein the polymer substrate comprises poly(dimethylsiloxane) (PDMS).

Clause 13: The method of clause 9, wherein treating the surface of the cured polymer substrate comprises exposing the surface to UV-ozone treatment.

Clause 14: The method of clause 9, wherein the curing temperature is at least 100 degrees Celsius.

Clause 15: The method of clause 9, wherein depositing the silanized chitosan sol comprises spin-coating the silanized chitosan sol onto the treated surface.

Clause 16: The method of clause 9, wherein the curing temperature is selected to control a stiffness of the polymer substrate, and wherein increasing the stiffness of the polymer substrate increases a volume of the interface-confined water molecules in the chitosan layer.

Clause 17: A flexible polysaccharide film, comprising: a polysaccharide layer comprising amorphous hydrogen-bonded domains, the amorphous hydrogen-bonded domains comprising interface-confined water molecules held by hydrogen bonds within the polysaccharide layer; wherein the interface-confined water molecules comprise freezing bound water that exhibits a cold crystallization exotherm at a sub-zero temperature; wherein the polysaccharide layer exhibits a reduced elastic modulus relative to an unsoftened polysaccharide film of the same composition lacking the interface-confined water molecules; and wherein the polysaccharide layer is free of apparent surface moisture.

Clause 18: The flexible polysaccharide film of clause 17, wherein the polysaccharide layer comprises chitosan.

Clause 19: The flexible polysaccharide film of clause 17, wherein the polysaccharide layer exhibits a water contact angle that decreases with increasing hydro-softening, indicating increased surface hydrophilicity relative to the unsoftened polysaccharide film.

Clause 20: The flexible polysaccharide film of clause 17, wherein the polysaccharide layer exhibits a mass decomposition above 100 degrees Celsius that is greater than a mass decomposition of the unsoftened polysaccharide film, as measured by thermogravimetric analysis.

A number of implementations have been described. Nevertheless, it will be understood that various modifications may be made without departing from the spirit and scope of the disclosure. Accordingly, other implementations are within the scope of the following claims.

1. A hydro-softened chitosan film, comprising:
a chitosan layer comprising interface-confined water molecules entrapped within amorphous hydrogen-bonded domains of the chitosan layer, wherein the interface-confined water molecules comprise freezing bound water held by hydrogen bonds between amine and hydroxyl groups of the chitosan layer;
wherein the chitosan layer exhibits an elastic modulus that is reduced relative to an unsoftened chitosan film lacking the interface-confined water molecules; and
wherein the chitosan layer is free of apparent surface moisture.

2. The hydro-softened chitosan film of claim 1, wherein the chitosan layer has a chitosan purity of at least 75 weight percent.

3. The hydro-softened chitosan film of claim 1, wherein the chitosan layer has a chitosan purity of at least 80 weight percent.

4. The hydro-softened chitosan film of claim 1, wherein the chitosan layer exhibits a softness, defined as an inverse of the elastic modulus, of at least 10⁻⁸ Pa⁻¹.

5. The hydro-softened chitosan film of claim 1, wherein the chitosan layer exhibits an elastic modulus of about 35 MPa or less.

6. The hydro-softened chitosan film of claim 1, wherein the interface-confined water molecules exhibit a cold crystallization exotherm at a sub-zero temperature when measured by differential scanning calorimetry.

7. The hydro-softened chitosan film of claim 1, wherein the chitosan layer exhibits a distinct O-H absorption peak at approximately 3400 cm⁻¹ superimposed on a broad amine-hydroxyl band between 3200 and 3500 cm⁻¹ when measured by Fourier transform infrared spectroscopy.

8. The hydro-softened chitosan film of claim 1, further comprising a poly(dimethylsiloxane) (PDMS) substrate, wherein the chitosan layer is disposed on the PDMS substrate.

9. A method of fabricating a hydro-softened chitosan film, comprising:
preparing a chitosan solution by dissolving and protonating chitosan in a dilute acidic solution;
adding a silane precursor to the chitosan solution to form a silanized chitosan sol;
preparing a polymer substrate;
curing the polymer substrate at a curing temperature;
treating a surface of the cured polymer substrate to introduce hydroxyl groups on the surface;
depositing the silanized chitosan sol onto the treated surface of the cured polymer substrate; and
allowing condensation of the silanized chitosan sol on the treated surface to form a chitosan layer having interface-confined water molecules entrapped within amorphous hydrogen-bonded domains of the chitosan layer.

10. The method of claim 9, wherein the silane precursor comprises tetraethyl orthosilicate (TEOS).

11. The method of claim 9, wherein the silane precursor is added to achieve a degree of substitution of about 40%.

12. The method of claim 9, wherein the polymer substrate comprises poly(dimethylsiloxane) (PDMS).

13. The method of claim 9, wherein treating the surface of the cured polymer substrate comprises exposing the surface to UV-ozone treatment.

14. The method of claim 9, wherein the curing temperature is at least 100 degrees Celsius.

15. The method of claim 9, wherein depositing the silanized chitosan sol comprises spin-coating the silanized chitosan sol onto the treated surface.

16. The method of claim 9, wherein the curing temperature is selected to control a stiffness of the polymer substrate, and wherein increasing the stiffness of the polymer substrate increases a volume of the interface-confined water molecules in the chitosan layer.

17. A flexible polysaccharide film, comprising:
a polysaccharide layer comprising amorphous hydrogen-bonded domains, the amorphous hydrogen-bonded domains comprising interface-confined water molecules held by hydrogen bonds within the polysaccharide layer;
wherein the interface-confined water molecules comprise freezing bound water that exhibits a cold crystallization exotherm at a sub-zero temperature;
wherein the polysaccharide layer exhibits a reduced elastic modulus relative to an unsoftened polysaccharide film of the same composition lacking the interface-confined water molecules; and
wherein the polysaccharide layer is free of apparent surface moisture.

18. The flexible polysaccharide film of claim 17, wherein the polysaccharide layer comprises chitosan.

19. The flexible polysaccharide film of claim 17, wherein the polysaccharide layer exhibits a water contact angle that decreases with increasing hydro-softening, indicating increased surface hydrophilicity relative to the unsoftened polysaccharide film.

20. The flexible polysaccharide film of claim 17, wherein the polysaccharide layer exhibits a mass decomposition above 100 degrees Celsius that is greater than a mass decomposition of the unsoftened polysaccharide film, as measured by thermogravimetric analysis.
